(19) United States
(12) Patent Application Publication
(10) Pub. No.: US 2022/0313406 A1
(43) Pub. Date: Oct. 6, 2022

(54) MOUTH CLEANING DEVICE, SYSTEM PROVIDED THEREWITH AND METHOD THEREFOR

(71) Applicant: GUM IRRIGATOR B.V., Groningen (NL)

(72) Inventor: Sophie Antoinette Van Dijk, Amsterdam (NL)

(21) Appl. No.: 17/616,670

(22) PCT Filed: Jun. 5, 2020
(86) PCT No.: PCT/NL2020/050368

§ 371 Date: Dec. 5, 2021

(30) Foreign Application Priority Data
Jun. 5, 2019 (NL) 2023266

(51) Int. Cl. A61C 17/02; A61C 17/028

(52) U.S. Cl. CPC A61C 17/0202; A61C 17/028

(57) ABSTRACT

The present invention relates to a mouth cleaning device using incoming fluid, a mouth cleaning system comprising such device and a method for using the mouth cleaning device. The mouth cleaning device comprises: a housing extending in a longitudinal direction comprising: an incoming fluid inlet; an outgoing fluid outlet; a cleaning head with an incoming fluid outlet and an outgoing fluid inlet; and a cleaning head connector configured for connecting the cleaning head to the housing, and the cleaning head connector comprising an incoming fluid channel configured for operatively connecting the incoming fluid inlet and incoming fluid outlet, and an outgoing fluid channel configured for operatively connecting the outgoing fluid inlet and outgoing fluid outlet, wherein the cleaning head connector comprises an incoming fluid connection and an outgoing fluid connection that are provided at a connection distance in the longitudinal direction of the housing.

The present invention relates to a mouth cleaning device, such as a periodontal cleaning device. The mouth cleaning device is a handheld device for cleaning for example gum. The invention further relates to a mouth cleaning system and method for using the mouth cleaning device.

Mouth cleaning devices are known from the state of the art. One embodiment of a mouth cleaning device is disclosed in WO2016/198632. Disclosed is a mouth cleaning device comprising a fluid feed line for providing cleaning fluid, a suction line for outgoing fluid, and a cleaning head. The cleaning fluid is provided to the cleaning head and released through the fluid outlet in the mouth of the patient, while through the suction outlet of the cleaning head the outgoing fluid is removing the outgoing fluid from the mouth of the patient.

The known mouth cleaning device has several disadvantages. One disadvantage is that inside the mouth cleaning device the cleaning fluid and the outgoing fluid have the risk of being mixed which may contaminate the cleaning fluid. In addition, this lowers the effectiveness of the mouth cleaning device.

The objective of the present invention is to provide a mouth cleaning device that obviates or at least reduces one or more of the above stated problems. In particular an object of the present invention is to provide a mouth cleaning device wherein mixing of the incoming fluid, such as cleaning fluid or saliva-stimulating fluid, and outgoing fluid, such as waste fluid, is prevented.

This is achieved with a mouth cleaning device, wherein the mouth cleaning device comprises:
a housing extending in a longitudinal direction comprising:
   a housing incoming fluid inlet;
   a housing outgoing fluid outlet;
a cleaning head with a head incoming fluid outlet and a head outgoing fluid inlet; and
a cleaning head connector configured for connecting the cleaning head to the housing, and the cleaning head connector comprising a incoming fluid channel configured for operatively connecting the housing incoming fluid inlet and head incoming fluid outlet, and a outgoing fluid channel configured for operatively connecting the head outgoing fluid inlet and the housing outgoing fluid outlet,
wherein the cleaning head connector comprises an incoming fluid connection and a outgoing fluid connection that are provided at a connection distance in the longitudinal direction of the housing.

The mouth cleaning device is for example a periodontal cleaning device. Experiments have shown that the present invention particularly has advantageous effects when applied on a periodontal cleaning device.

By providing an incoming fluid connection and a outgoing fluid connection provided at a connection distance in the longitudinal direction the chance of mixing or leaking of the incoming fluid and the outgoing fluid is reduced. The connection distance establishes that the chance of leaking from the incoming fluid connection to the outgoing fluid connection is reduced, because two separate circuits, one for the incoming fluid and one for the outgoing fluid, are established. Only in the mouth of the patient, at the tip of the cleaning head, the incoming fluid and the outgoing fluid are (virtually in contact with each other. Next to this, if a leaking would occur at the incoming fluid connection or the outgoing fluid connection, the outgoing fluid has the overcome a larger distance to come into the incoming fluid. This significantly reduces the risk of any contamination of the incoming fluid. Furthermore, the connection distance provides the ability for a tighter and more stable connection between the housing and the cleaning head connector. Additionally, providing a connection distance reduces the chance of contamination of the incoming fluid and the outgoing fluids during cleaning. The connection distance also provides that the contact surfaces between the housing and the cleaning head connector is larger, thereby reducing the chance of leakage between the housing and the cleaning head connector. It is noted that fluid relates to liquids, such as cleaning liquid, and/or to gases. Optionally, liquid(s) and gas(es) are used in a multiple inlet/outlet cleaning device.

Providing a housing extending in a longitudinal direction provides a handheld device that is easy to grab with one hand. By comprising a housing incoming fluid inlet and a housing outgoing fluid outlet, the mouth cleaning device provides the ability for the mouth cleaning device to be connected to a mouth cleaning system comprising a incoming fluid reservoir and a outgoing fluid reservoir. The incoming fluid can be supplied from the incoming fluid reservoir to the housing incoming fluid inlet, while the outgoing fluid reservoir can be supplied from the housing outgoing fluid outlet to the outgoing fluid reservoir.

Providing a cleaning head with a head incoming fluid outlet and a head outgoing fluid inlet gives the mouth cleaning device the ability to supply incoming fluid to the mouth of the patient through the head incoming fluid outlet, while also removing outgoing fluid from the mouth of the patient through the head outgoing fluid inlet, preferably by sucking the outgoing fluid through the head outgoing fluid inlet. Preferably, the head incoming fluid outlet and the head outgoing fluid inlet are provided at or adjacent the tip of the cleaning head.

Providing a cleaning head connector provides a way to connect the cleaning head with the housing. By placing the connector between the cleaning head and the housing, a incoming fluid channel is created for operatively connecting the incoming fluid inlet and the incoming fluid outlet, and a outgoing fluid channel is created for operatively connecting the outgoing fluid inlet and the outgoing fluid outlet.

The cleaning head connector further comprises a connector incoming fluid inlet, a connector incoming fluid outlet, a connector outgoing fluid inlet and a connector outgoing fluid outlet. The incoming fluid channel stretches out/extends between the connector incoming fluid inlet and connector incoming fluid outlet, and the outgoing fluid channel stretches out/extends between the connector outgoing fluid inlet and the connector outgoing fluid outlet.

The housing further comprises housing incoming fluid outlet, a housing outgoing fluid inlet, a housing incoming fluid conduit extending from the housing incoming fluid inlet to the housing incoming fluid outlet, and a housing outgoing fluid conduit extending from the housing outgoing fluid inlet to the housing outgoing fluid outlet.

The cleaning head further comprises a head incoming fluid inlet, a head outgoing fluid outlet, a head incoming fluid conduit extending from the head incoming fluid inlet to the head incoming fluid outlet, and a head outgoing fluid conduit extending from the head outgoing fluid inlet to the head outgoing fluid outlet. In one embodiment the mouth cleaning device comprises more than one head incoming fluid conduits, for example two head incoming fluid conduits.

The incoming fluid connection is the (operative) connection between the housing incoming fluid outlet and the head incoming fluid inlet. The outgoing fluid connection is the (operative) connection between the head outgoing fluid outlet and the housing outgoing fluid inlet.

In an embodiment according to the invention the length of the housing incoming fluid conduit is larger as compared to the length of the housing outgoing fluid conduit in the longitudinal direction. This enables an effective provision of a connections distance between the incoming fluid and outgoing fluid connections.

Preferably, the housing, the cleaning head and the cleaning head connector are all removably attached to each other. More preferably, the cleaning head connector has on its outside an edge whereon the cleaning head can be clicked. Alternatively, the cleaning head connector comprises a threaded surface on its outside whereon the cleaning head may be screwed. Thus in practice the cleaning head connector is removably attached to the housing, while the cleaning head is removably attached to the cleaning head connector.

In a further embodiment according to the invention the mouth cleaning device comprises a filter.

By providing a filter reduces the chance of the mouth cleaning device being clogged. The filter is preferably placed in the suction line for the filtering of the outgoing fluid. During use, outgoing fluid will contain larger solid parts of for example dental plaque. This may clog the outgoing fluid conduit or the pump for pumping the incoming fluid and sucking the outgoing fluid. The advantage of the filter is that the larger solid parts will be filtered out.

In a further embodiment according to the invention the filter is provided in or attached to the cleaning head connector.

By providing the filter in or attached to the cleaning head connector the filter is easily removable. This is due to the fact that the housing, the cleaning head and the cleaning head connector are all removably attached to each other. In one embodiment, removing the cleaning head from the cleaning head connector is sufficient for removing or changing the filter. This enables efficient replacing of the filter. In another embodiment, one also needs to remove the cleaning head connector for removing or changing the filter.

In a further embodiment according to the invention the connection between the housing and the cleaning head connector comprises a housing contact surface in contact with a connector contact surface.

The contact surfaces of the housing and the cleaning head connector are the surfaces which are in contact when the cleaning head connector is connected with the housing. Preferably, the contact surface of the housing is a male part of the coupling between the housing and the cleaning head connector and the contact surface of the cleaning head connector is a female part of the coupling between the housing and the cleaning head connector. Preferably, the housing has two contacting surfaces, both of a male part of the coupling between the housing and the cleaning head connector. Alternatively, the contact surface(s) of the housing is (are) female parts, while the contact surface(s) of the cleaning head connector is (are) male parts. In one embodiment the male parts are placed on top of each other. Providing contacting surfaces which are embodied as male and female parts gives the connection between the housing and the cleaning head connector a more stable and more liquid-tight connection.

In a further embodiment according to the invention the incoming fluid connection of the cleaning head connector comprises a Luer lock coupling.

Providing a Luer lock coupling at the incoming fluid connection gives the incoming fluid connection a highly reliable leak-free connection. Because of the specific male coupling with the female coupling the chance of leaking of the fluid connection is highly reduced. This in turn reduces the chance of mixing between incoming fluid and outgoing fluid. Preferably, the male connection is the housing incoming fluid outlet, while the female connection is the connector incoming fluid inlet.

In a further embodiment according to the invention the outgoing fluid connection of the cleaning head connector comprises a Luer lock coupling.

Providing a Luer lock coupling at the outgoing fluid connection gives the outgoing fluid connection a leak-free connection. This further reduces the chances of leakage, and thus of mixing between the incoming fluid and the outgoing fluid.

In a further embodiment according to the invention the connection between the head incoming fluid inlet and the connector incoming fluid outlet comprises a Luer lock coupling.

In a presently preferred embodiment the relevant connections in the device each comprise a Luer lock coupling. This provides a substantially leak-free device that is relatively easy to assemble/disassemble.

In a further preferred embodiment according to the invention the cleaning head connector comprises a closing ring that is configured to provide sufficient force for the Luer lock coupling or couplings in an operative state of the device.

The closing ring is removably attached to the housing and the cleaning head connector. By placing a closing ring the cleaning head connector is pressed harder against the housing, which provides a more steady incoming fluid and outgoing fluid connection. The closing is preferably attached to both the housing and the cleaning head connector with a threaded connection. As a further effect, the closing ring achieves robust fluid connection that further minimizes the risk of incorrect coupling individual parts of the device.

In a further embodiment according to the invention the head incoming fluid conduit is a disposable conduit.

By providing the incoming fluid conduit as a disposable conduit one achieves an easy way to clean or replace the incoming fluid conduit of the mouth cleaning. When detaching the cleaning head from the cleaning head connector, one is able to remove the head incoming fluid conduit. After removal the cleaning head incoming fluid conduit can be cleaned, or replaced by another head incoming fluid conduit. In use the head incoming fluid inlet is attached to the connector incoming fluid outlet.

In a further embodiment according to the invention the head outgoing fluid conduit substantially surrounds the head incoming fluid conduit.

By providing the head outgoing fluid conduit substantially surrounding the head incoming fluid conduit the head outgoing fluid conduit is positioned at the outside of the cleaning head. This gives extra security to the head incoming fluid conduit. Furthermore, providing the head outgoing fluid conduit substantially surrounding the head incoming fluid conduit has the advantage that, if there would be damage at the outside of the cleaning head, only the head outgoing fluid conduit would be affected and the head incoming fluid conduit would be intact.

In a further embodiment according to the invention the head outgoing fluid conduit is at least partially transparent.

By providing the head outgoing fluid conduit at least partially transparent, one is able to see through the walls of the head outgoing fluid conduit. One advantage hereof is that the outgoing fluid going through the head outgoing fluid conduit can be visually inspected during use of the mouth cleaning device.

In a further embodiment according to the invention the mouth cleaning device further comprises a controller configured for controlling the flow or flows through the device.

By providing a controller the flow rate of the incoming fluid and outgoing fluid can be controlled. This flow rate can be adjusted for example on the amount of dental plaque in the patient's mouth, or on the visual inspection done on the head outgoing fluid conduit. This ensures a correct functioning of the mouth cleaning device, as too little or too much cleaning and/or outgoing fluid in the mouth of the patient will reduce the effectiveness of the cleaning and/or the negatively impact the experience of the patient during cleaning. Optionally, one or more sensors can be provided that provide the controller with information about the condition(s) of the outgoing fluid, for example. This improves the efficiency of the cleaning operation.

The invention further relates to a mouth cleaning system, wherein the mouth cleaning system comprises:
a mouth cleaning device according to the present invention; and
a base station configured for receiving the mouth cleaning device.

The mouth cleaning system has the same effects and advantages as described for the mouth cleaning device.

In a further embodiment according to the invention the mouth cleaning system further comprises a incoming fluid reservoir and a outgoing fluid reservoir.

Providing a incoming fluid reservoir has the advantage that a large amount of incoming fluid can be supplied to the mouth cleaning device, such that multiple cleaning operations can be performed. Providing a outgoing fluid reservoir obtains an easy way to save the outgoing fluid during use. This also allows for an inspection of the outgoing fluid. Furthermore, this enables a stand-alone system.

In a further embodiment according to the invention the mouth cleaning system further comprises a sensor, preferably a temperature sensor, a contamination level sensor, and/or a flow rate sensor.

Providing one of the sensors gives the user extra information about performance of the mouth cleaning device during use. This has the advantage that the use of the mouth cleaning device can be adjusted, for example the flow rates of the cleaning and/or outgoing fluid, thereby obtaining a more efficient performance of the mouth cleaning device.

The invention further relates to a method for operating a mouth cleaning device according to any of the foregoing claims, the method comprising the steps of:
providing a mouth cleaning device according to the present invention; and
operating the mouth cleaning device.

The method for operating the mouth cleaning device has the same effects and advantages as described for the mouth cleaning device and/or system.

Advantages, features and details of the invention are elucidated on the basis of preferred embodiments thereof, wherein reference is made to the accompanying drawings, in which:

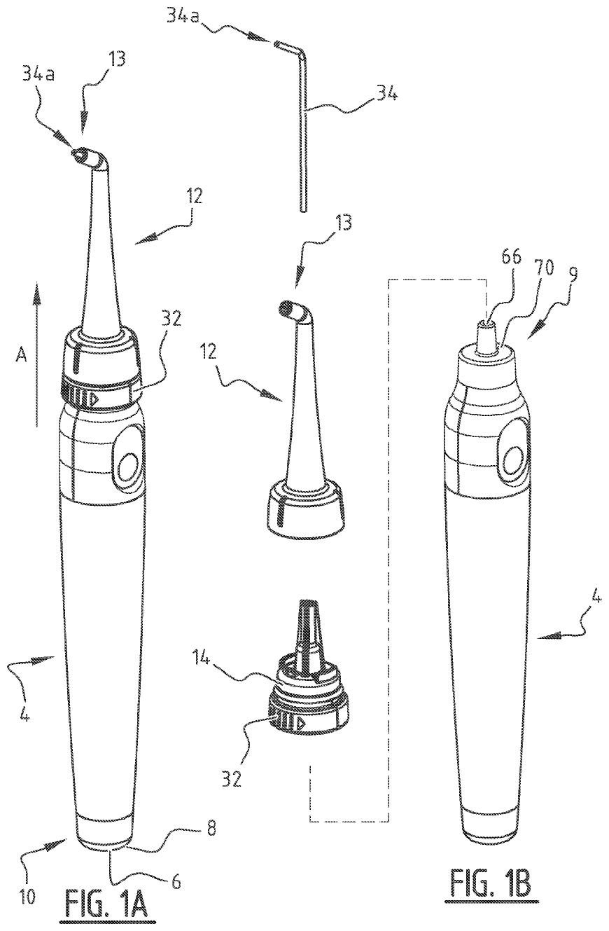

FIGS. 1 A-B show a perspective view of an example of a device according to the invention;

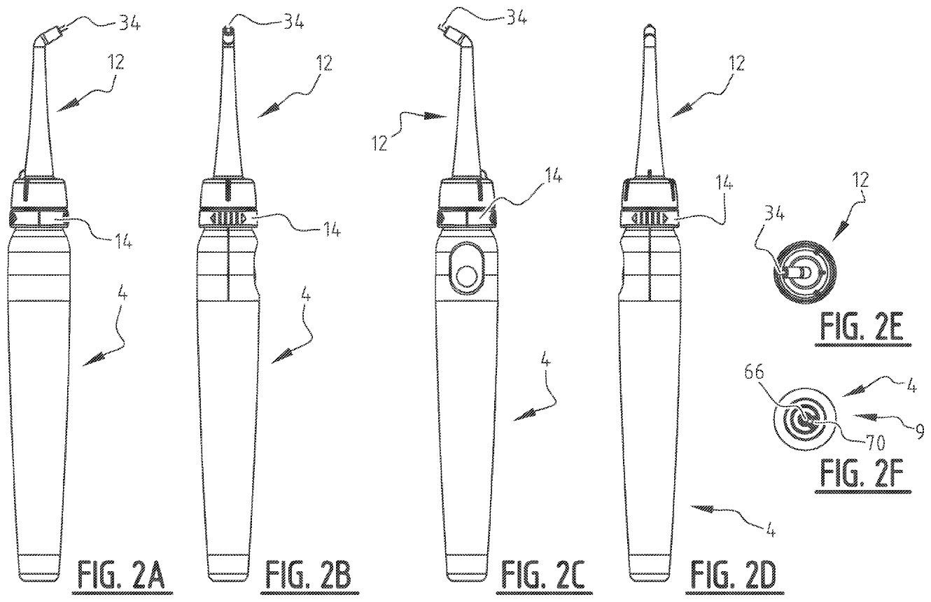

FIGS. 2 A-2D show side views of the example of FIG. 1;

FIGS. 2 E-2F show top views of the example of FIG. 1;

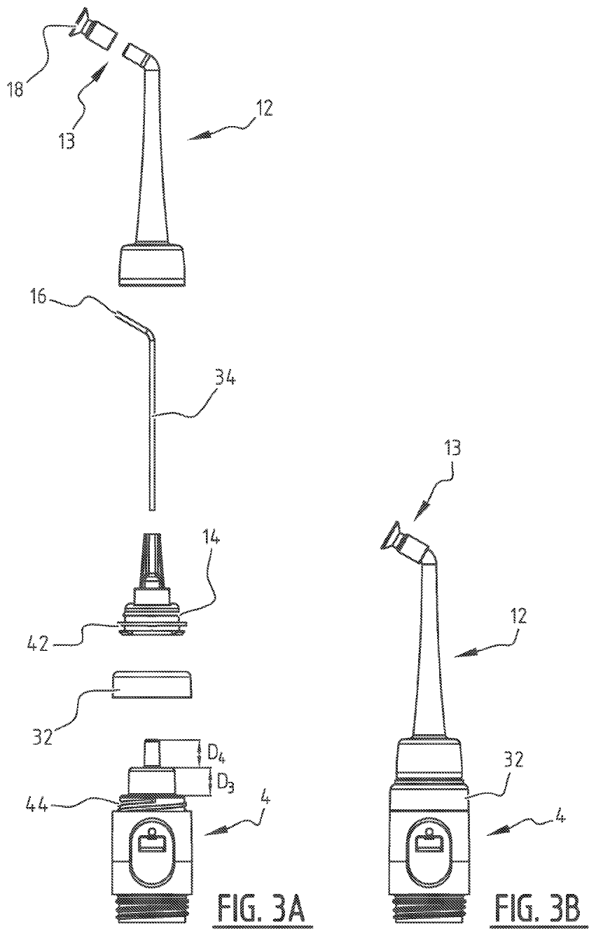

FIGS. 3 A-B show a detailed view of the cleaning head, housing and cleaning head connector of the example of the device of FIG. 1;

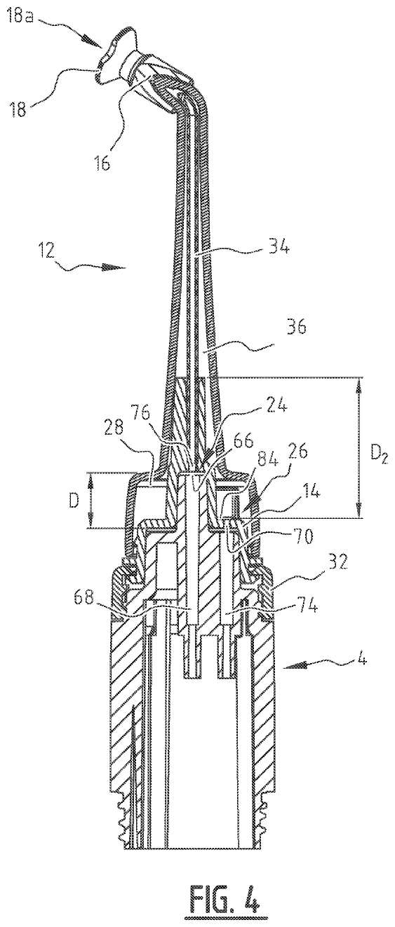

FIG. 4 shows a partial cross-section of the example of the device of FIG. 1;

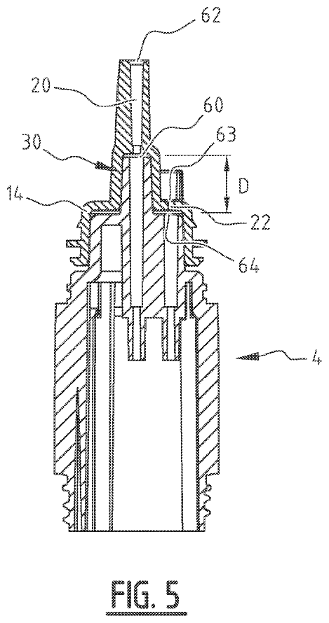

FIG. 5 shows a partial cross-section of the example of the device of FIG. 1 without the cleaning head;

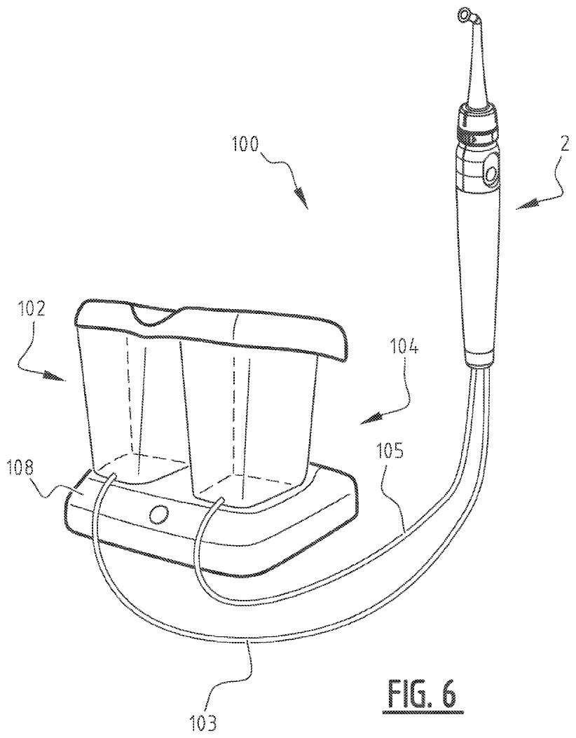

FIG. 6 shows an example of a system according to the invention; and

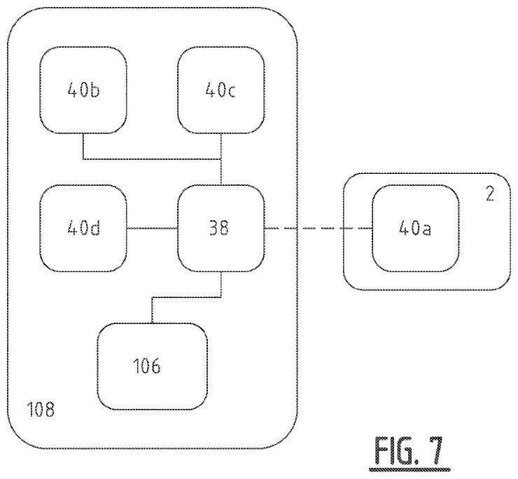

FIG. 7 shows an example of a mouth cleaning system according to the invention.

An example of mouth cleaning device 2 (see FIGS. 1-3) comprises housing 4 that extends in a longitudinal direction A over a length, and further comprises cleaning head 12 that at a lower end thereof is operatively connectable to an end portion of housing 4. Housing 4 comprises housing incoming fluid inlet 6 and housing outgoing fluid outlet 8, which in this example of housing 4 are both positioned near, or in this case in, lower outer end 10 of housing 4. In the illustrated embodiment housing incoming fluid inlet 6 and housing outgoing fluid outlet 8 are connectable to respectively a incoming fluid container for containing incoming fluid to be used in mouth cleaning and a outgoing fluid container for receiving outgoing fluid from the mouth cleaning. Such a connection may be formed for example by means of a click-lock connection or a screw connection. In this example, the housing incoming fluid inlet 6 and housing outgoing fluid outlet 8 are connectable to the respective containers via (separate) conduits (not shown). Cleaning head 12 further comprises head incoming fluid conduit 34, which in this embodiment is preferably a disposable conduit 34 that partially extends from top part or tip 13 of cleaning head 12. In use, head incoming fluid conduit 34 is mostly positioned in cleaning head 12 and extends substantially centrally therein, with only a part 34a optionally extending outside top part 13 of cleaning head. Mouth cleaning device 2 further comprises cleaning head connector 14 that connects cleaning head 12 and housing 4 with each other. Housing 4 further comprises housing incoming fluid outlet 66 and housing outgoing fluid inlet 70. Head incoming fluid conduit 34 is operatively or even directly (releasable) connectable to housing incoming fluid outlet 66, such that incoming fluid from a incoming fluid container is guidable via housing incoming fluid inlet 6 via a conduit in housing 4 (not shown), housing incoming fluid outlet 66 and head incoming fluid conduit 34 to a person's mouth. In the presently preferred embodiment mouth cleaning device comprises nozzle 18 (illustrated in FIGS. 3 A-B), preferably made of a silicon material.

Side views of mouth cleaning device 2 (FIGS. 2A-2D) show housing 4, cleaning head 12 and cleaning head connector 14 in more detail. Specifically, FIGS. 2A-2D shows that in the illustrated embodiment top part 13 of cleaning head 12 is positioned under a slight angle with respect to a central axis (extending in direction A) of device 2. This improves the handling and positioning of device 2. This also means that head incoming fluid conduit 34 emanates from top part 13 of cleaning 12 under an angle, which is also shown from a top view (FIG. 2E). Housing 4 (without connector 14 and cleaning head 12 attached to it) is also shown from a top view (FIG. 2F). It is clearly visible that housing incoming fluid outlet 66 and housing outgoing fluid inlet 70 are provided at upper outer end 9 of mouth cleaning device 2. Also visible is that, with respect to central axis A, housing outgoing fluid inlet 70 is positioned radially more outward than incoming fluid outlet 66 of housing 4. It is noted that housing incoming fluid outlet 66 is provided higher with respect to housing 4 than housing outgoing fluid inlet 70. This configuration provides for a fluidly disconnected and spatially separated configuration of the incoming fluid flow and the outgoing fluid flow. Preferably, the incoming fluid flow is provided more centrally and the outgoing fluid flow is (partly) surrounding the fluid flow. This provides additional protection for the incoming fluid flow. In the illustrated embodiments the design is such that there are no abrupt or big shape changes such that the accumulation of dirt is avoided and cleaning of the mouth cleaning device is made easier.

Mouth cleaning device 2 further comprises closing ring 32, which is shown in more detail in FIG. 3A. Closing ring 32 can be screwed between connector edge 42 of cleaning head connector 14 and housing threading 44 of housing 4 to provide an extra secure connection between connector 14 and housing 4, thereby preventing leaking. Further denoted in FIG. 3A are distances D3 and D4, which provide that the connection between housing 4 and cleaning head connector 14 is even more stable and fluid-tight. FIG. 3B shows mouth cleaning device 2 with the parts of FIG. 3A attached to each other. Mouth cleaning device 2 further comprises nozzle 18, which is connectable to top part 13 of cleaning head 12. Nozzle 18 comprises a connection with end part 34a of incoming fluid conduit 34 as well as a connection with outgoing fluid conduit 36 that extends parallel and concentric with conduit 34 within cleaning head 12.

Cleaning head 12 (FIG. 4) is provided with a head incoming fluid conduit 34 and a head outgoing fluid conduit 36 which is concentric with (and thus substantially surrounds) head incoming fluid conduit 34. Head incoming fluid conduit 34 extends from head cleaning inlet 76 to head incoming fluid outlet 16 and head outgoing fluid conduit 36 extends from head outgoing fluid inlet 18a to head outgoing fluid outlet 84. Incoming fluid connection 24 is the connection between housing incoming fluid outlet 66 and head incoming fluid inlet 76. In this embodiment incoming fluid connection 24 is a Luer lock connection. Outgoing fluid connection 26 is the connection between head outgoing fluid outlet 84 and housing outgoing fluid inlet 70. Filter 28 is provided near cleaning head connector 14. Connections 24, 26 are provided at a relative distance referred to as connection distance D. Connection distance D is the distance measured in longitudinal direction A between housing incoming fluid outlet 66 and housing outgoing fluid inlet 70. Connection distance D establishes that the incoming fluid flow and the outgoing fluid flow become separate flows that are substantially not fluidly connected to each other, such that fouling of the incoming fluid flow is prevented. In the illustrated embodiment head cleaning conduit 34 is provided in incoming fluid connection 24. Alternatively, it is possible that another connection is provided such that incoming fluid conduit 34 is connected to incoming fluid channel 20 with a Luer lock coupling.

In the illustrated embodiment cleaning head connector 14 (FIG. 5) further comprises cleaning channel 20 extending from connector incoming fluid inlet 60 to connector incoming fluid outlet 62, and further comprises outgoing fluid channel 22 extending from connector outgoing fluid inlet 63 to connector outgoing fluid outlet 64. Head incoming fluid conduit 34 extends at least partially within cleaning channel 20 of cleaning head connector 14 to create a fluidly tight connection that prevents ingress of outgoing fluid from outgoing fluid channel 36. Therewith an additional safeguard against fouling of incoming fluid is prevented. Cleaning channel 20 has a longer length measured in longitudinal direction A than outgoing fluid channel 22. This provides that connector connection distance D2 (FIG. 4) is longer than connection distance D.

Mouth cleaning system 100 (FIG. 6) comprises mouth cleaning device 2 connected to incoming fluid reservoir 102 and outgoing fluid reservoir 104 by conduits 103, 105 respectively. Sensor 40a is provided near or in end portion 10 of mouth cleaning device 2 for measuring the flow rate of the incoming fluid and outgoing fluid (see FIG. 7). Mouth cleaning system 100 further includes drive 106 for pumping incoming fluid to nozzle 18 and sucking outgoing fluid from nozzle 18. In mouth cleaning system 100, drive 106 is preferably embodied as a pump (see FIG. 7). Drive 106 is controlled by controller or control unit 38, for controlling the flow rate of the incoming fluid and outgoing fluid. Controller 38 can regulate drive 106 such that for example the supply of incoming fluid and the suction of outgoing fluid are continuous during use, or in an alternative embodiment such that the supply pulse and the suction pulse are at predetermined intervals. In some embodiments controller 38 provides a pausing period between a supply pulse and a suction pulse, for example in the range of 150-500 ms. Furthermore, housing 108 may further also comprise a number of sensors 40b-40d, which may be flow sensors, contamination sensors, fluid level sensors and/or temperature sensors. Sensors 40b-40d are in this example positioned in housing 108 of mouth cleaning system 100 (see FIG. 7), yet may also be (additionally) positioned in reservoirs 102, 104 and/or conduits 103, 105 of mouth cleaning system 100.

In use, incoming fluid in mouth cleaning system 2 flows from incoming fluid reservoir 102 subsequently through housing incoming fluid inlet 6, housing incoming fluid conduit 68, housing incoming fluid outlet 66, connector incoming fluid inlet 60, incoming fluid channel 20, connector incoming fluid outlet 62, head incoming fluid inlet 76, head incoming fluid conduit 34 and head incoming fluid outlet 16 into a persons mouth. The outgoing fluid subsequently flows from head outgoing fluid inlet 18a through head outgoing fluid conduit 36, head outgoing fluid outlet 84, connector outgoing fluid inlet 63, outgoing fluid channel 22, connector outgoing fluid outlet 64, housing outgoing fluid inlet 70, housing outgoing fluid conduit 74, housing outgoing fluid outlet 8 to outgoing fluid reservoir 104.

In an embodiment according to the invention mouth cleaning device 2 is used to perform a mouth cleaning action. A user of the device, the operator, starts cleaning a persons mouth by providing incoming fluid from the housing incoming fluid inlet 6 to head incoming fluid outlet 16. At the same time outgoing fluid from the persons mouth is sucked in via head outgoing fluid inlet 18a to housing outgoing fluid outlet 8. After the mouth cleaning action, the operator releases closing ring 32 by screwing it off to de-attach cleaning head 12 from housing 4 and subsequently changes the used head incoming fluid conduit 34 for a new one. This is made possible due to the fact that cleaning head 12 is de-attached from housing 4 and head incoming fluid conduit 34 can thus be removed from cleaning head connector 14. After insertion of new incoming fluid conduit 34, cleaning head 12 can be attached to housing 4 and closing ring can be screwed on for a tighter closing of cleaning head 12 on housing 4. Then mouth cleaning device 2 can be used by the operator for the next person.

Mouth cleaning device 2 can be advantageously applied as periodontal cleaning device. This preferably involves achieving the correct pressure and pulses by controller 38, and an appropriate cleaning head 12, for example.

The present invention is by no means limited to the above described preferred embodiments thereof. The rights sought are defined by the following claims within the scope of which many modifications can be envisaged. For example, the mouth cleaning device could comprise two head incoming fluid conduits.

1. A mouth cleaning device comprising:
a housing extending in a longitudinal direction comprising:
a incoming fluid inlet;
a outgoing fluid outlet;
a cleaning head with an incoming fluid outlet and an outgoing fluid inlet; and a cleaning head connector configured for connecting the cleaning head to the housing, and the cleaning head connector comprising an incoming fluid channel configured for operatively connecting the incoming fluid inlet and incoming fluid outlet, and an outgoing fluid channel configured for operatively connecting the outgoing fluid inlet and outgoing fluid outlet,
wherein the cleaning head connector comprises an incoming fluid connection and an outgoing fluid connection that are provided at a connection distance in the longitudinal direction of the housing.

2. The mouth cleaning device according to claim 1, further comprising a filter.

3. The mouth cleaning device according to claim 2, wherein the filter is provided in or attached to the cleaning head connector.

4. The mouth cleaning device according to claim 1, wherein the connection between the housing and the cleaning head connector comprises a housing contact surface in contact with a connector contact surface.

5. The mouth cleaning device according to claim 1, wherein the incoming fluid connection of the cleaning head connector comprising a Luer lock coupling.

6. The mouth cleaning device according to claim 5, wherein the outgoing fluid connection of the cleaning head connector comprising a Luer lock coupling.

7. The mouth cleaning device according to claim 5, wherein the cleaning head connector comprises a closing ring that is configured to provide sufficient force for the Luer lock coupling in an operative state of the device.

8. The mouth cleaning device according to claim 1, wherein a head incoming fluid conduit is a disposable conduit.

9. The mouth cleaning device according to claim 1, wherein the outgoing fluid channel substantially surrounds the head incoming fluid conduit.

10. The mouth cleaning device according to claim 9, wherein the head outgoing fluid channel is at least partially transparent.

11. The mouth cleaning device according to claim 1, further comprising a controller configured for controlling the flow or flows through the device.

12. A mouth cleaning system comprising:
a mouth cleaning device comprising:
a housing extending in a longitudinal direction comprising:
an incoming fluid inlet; and
and outgoing fluid outlet;
a cleaning head with an incoming fluid outlet and an outgoing fluid inlet; and a cleaning head connector configured for connecting the cleaning head to the housing, and the cleaning head connector comprising an incoming fluid channel configured for operatively connecting the incoming fluid inlet and incoming fluid outlet, and an outgoing fluid channel configured for operatively connecting the outgoing fluid inlet and outgoing fluid outlet, wherein the cleaning head connector comprises an incoming fluid connection and an outgoing fluid connection that are provided at a connection distance in the longitudinal direction of the housing; and
a base station configured for receiving the mouth cleaning device.

13. The mouth cleaning system according to claim 12, further comprising an incoming fluid reservoir and an outcoming fluid reservoir.

14. The mouth cleaning system according to claim 12, further comprising a sensor, preferably a temperature sensor, a contamination level sensor, and/or a flow rate sensor.

15. The mouth cleaning system according to claim 13, wherein the mouth cleaning system comprises a periodontal cleaning system.

16. A method for operating a mouth cleaning device according to claim 1, comprising the steps of:
providing a mouth cleaning device; and
operating the mouth cleaning device.
